(19) United States
(12) Patent Application Publication
(10) Pub. No.: US 2025/0300563 A1
(43) Pub. Date: Sep. 25, 2025

(54) MULTI-PHASE POWER SOURCE CIRCUIT

(71) Applicant: DENSO CORPORATION, Kariya-city (JP)

(72) Inventors: FUMIKAZU NIHEI, Kariya-city (JP); RYOTARO KUNO, Kariya-city (JP)

(21) Appl. No.: 19/071,170

(22) Filed: Mar. 5, 2025

(30) Foreign Application Priority Data
Mar. 19, 2024 (JP) 2024-043459

(51) Int. Cl. H02M 3/158; H02M 1/32

(52) U.S. Cl. CPC H02M 3/1586; H02M 1/32

(57) ABSTRACT

A multi-phase power source circuit includes: a plurality of DC-DC converters; and a control unit configured to operate each of the plurality of DC-DC converters for a predetermined operation time in a predetermined switching period so that operation periods of the plurality of DC-DC converters are shifted from one another. The control unit is configured, when a failure is detected in any of the plurality of DC-DC converters, to change the predetermined switching period or the predetermined operation time of remaining DC-DC converters other than a failure DC-DC converter so as to compensate for an output of the failure DC-DC converter.

### CROSS REFERENCE TO RELATED APPLICATION

The present application claims the benefit of priority from Japanese Patent Application No. 2024-043459 filed on Mar. 19, 2024. The entire disclosure of the above application is incorporated herein by reference.

### TECHNICAL FIELD

The present disclosure relates to a multi-phase power source circuit.

### BACKGROUND

The multi-phase DC/DC converter according to a conceivable technique operates by shifting the output phases of multiple DC/DC converters connected in parallel and adds up the outputs to generate a desired output voltage from an input voltage.

### SUMMARY

According to an example, a multi-phase power source circuit may include: a plurality of DC-DC converters; and a control unit configured to operate each of the plurality of DC-DC converters for a predetermined operation time in a predetermined switching period so that operation periods of the plurality of DC-DC converters are shifted from one another. The control unit is configured, when a failure is detected in any of the plurality of DC-DC converters, to change the predetermined switching period or the predetermined operation time of remaining DC-DC converters other than a failure DC-DC converter so as to compensate for an output of the failure DC-DC converter.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a schematic configuration of a multi-phase power source circuit according to a first embodiment;

FIG. 2 is a diagram showing switching timings of each of the DC-DC converters in the multi-phase power source circuit according to the first embodiment;

FIG. 3 is a diagram illustrating outputs, response signals, and SW instruction signals of each of the DC-DC converters when a slave of the multi-phase power source circuit fails according to the first embodiment;

FIG. 4 is a diagram illustrating outputs, response signals, and SW instruction signals of each of the DC-DC converters when the daisy chain of the multi-phase power source circuit is interrupted according to the first embodiment;

FIG. 5 is a diagram illustrating SW instruction signals and response signals to each of the DC-DC converters in the multi-phase power source circuit according to the second embodiment;

FIG. 6 is a time chart showing the operation of each of the DC-DC converters in the multi-phase power source circuit according to the second embodiment; and

FIG. 7 is a diagram showing a schematic configuration of a multi-phase power source circuit according to a third embodiment.

### DETAILED DESCRIPTION

If any of the multiple DC/DC converters fails, the multi-phase DC/DC converter cannot continue to output a desired output voltage. As a result, a system that operates using the output of the multi-phase DC/DC converters may suddenly stop.

One aspect of the present disclosure provides a multi-phase power source circuit that can continue to provide a desired output even if any of a plurality of DC-DC converters fails.

A multi-phase power source circuit according to one aspect of the present disclosure includes a plurality of DC-DC converters and a control unit. The control unit is configured to operate each of the multiple DC-DC converters for a predetermined operating time in a predetermined switching period so that the operation periods of the multiple DC-DC converters are shifted from one another. In addition, the control unit is configured, when a failure is detected in any of the multiple DC-DC converters, to change the predetermined switching period or the predetermined operation time of the remaining DC-DC converters so as to compensate for the output of the failed DC-DC converter.

According to a multi-phase power source circuit according to one aspect of the present disclosure, when a failure is detected in any of the DC-DC converters, the switching periods or operating times of the remaining DC-DC converters are changed to compensate for the output of the failed DC-DC converter. Therefore, the multi-phase power source circuit can continue to provide the desired output even if any of the DC-DC converters fails.

### 1. First Embodiment

### <1-1. Configuration>

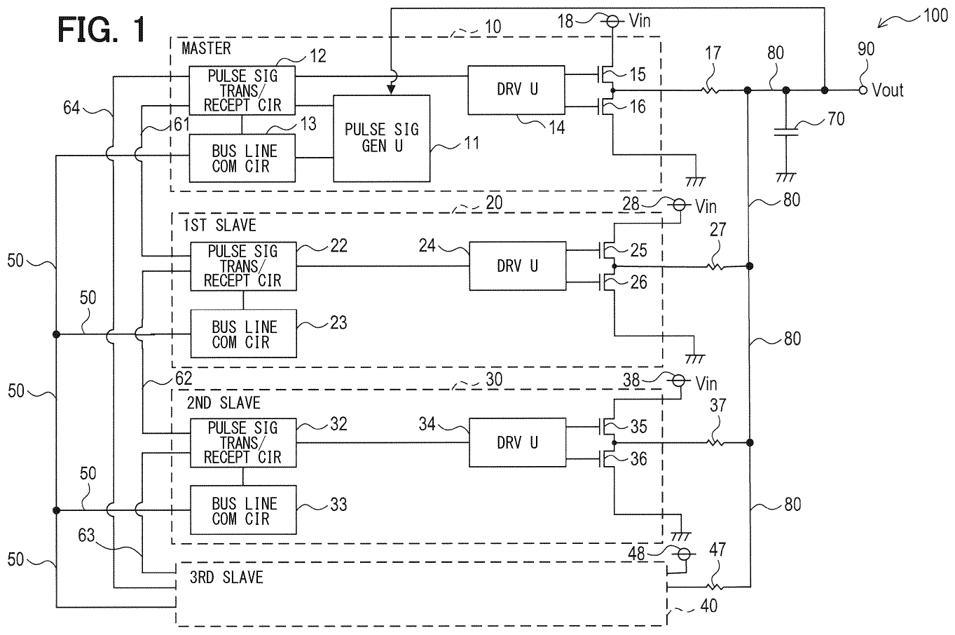

The configuration of a multi-phase power source circuit 100 according to a first embodiment will be described with reference to FIG. 1. In this embodiment, it is assumed that the multi-phase power source circuit 100 is arranged in a vehicle and supplies power to in-vehicle devices. In alternative embodiments, the multi-phase power source circuit 100 may be arranged outside of the vehicle and supplies power to a variety of electrical devices.

The multi-phase power source circuit 100 includes a master 10, a first slave 20, a second slave 30, a third slave 40, a bus line 50, daisy chain lines 61, 62, 63, and 64, a first resistor 17, a second resistor 27, a third resistor 37, a fourth resistor 47, a first power supply 18, a second power supply 28, a third power supply 38, a fourth power supply 48, a smoothing capacitor 70, an output line 80, and an output terminal 90.

The bus line 50 is a wiring that connects the master 10, the first slave 20, the second slave 30, and the third slave 40 in a bus system. In this embodiment, the bus line 50 corresponds to the first wiring of the present disclosure.

The daisy chain lines 61, 62, 63, and 64 are wirings that connect the master 10, the first slave 20, the second slave 30, and the third slave 40 in a daisy chain manner. In this embodiment, the daisy chain lines 61, 62, 63, and 64 correspond to the second wiring of the present disclosure.

The master 10 is connected to an output line 80 through a first resistor 17. The first slave 20 is connected to the output line 80 via a second resistor 27. The second slave 30 is connected to the output line 80 via a third resistor 37. The third slave 40 is connected to the output line 80 via a fourth resistor 47. The master 10, the first slave 20, the second slave 30 and the third slave 40 are connected to the output line 80 in parallel to each other via the first, second and third resistors 17, 27, 37 and 47, respectively.

The output line 80 is connected to an output terminal 90. The output terminal 90 is connected to an in-vehicle device (for example, an electronic control device) or various electric devices.

The smoothing capacitor 70 has a first pole and a second pole, the first pole is connected to the output line 80 and the second pole is grounded. Therefore, the first resistor 17, the second resistor 27, the third resistor 37, and the fourth resistor 47, together with the smoothing capacitor 70, form a smoothing circuit. That is, each of the master 10, the first slave 20, the second slave 30 and the third slave 40 is connected to the output terminal 90 via a smoothing circuit.

The multi-phase power source circuit 100 is a four-phase power source circuit having four converters, in which a master 10, a first slave 20, a second slave 30 and a third slave 40 operate with shifting each operation time by a predetermined time. In the multi-phase power source circuit 100, when the period from when the master 10 starts operating to when the master 10 next starts operating is defined as a switching period, the operation time of each of the master 10, the first slave 20, the second slave 30 and the third slave 40 is one-fourth of the switching period. The operation time is the time during which each DC-DC converter operates, and corresponds to the value obtained by dividing the switching period by the number of phases. In another embodiment, the multi-phase power source circuit 100 may be a two-phase or three-phase power supply circuit having two or three converters, or a five or more phase power supply circuit having five or more converters.

Each of the master 10, the first slave 20, the second slave 30 and the third slave 40 stores in advance a correspondence table between the number of operation phases and operation time in a predetermined switching period, and after detecting the number of phases, sets the operation time by referring to the correspondence table. When the operation time of the master 10 ends, the operation time of the first slave 20 starts, and when the operation time of the first slave 20 ends, the operation time of the second slave 30 starts. When the operation time of the second slave 30 ends, the operation time of the third slave 40 starts, and when the operation time of the third slave 40 ends, the operation time of the master 10 starts.

The master 10 is a DC-DC converter that functions as a master device, and includes a pulse signal generation unit 11, a pulse signal transmission/reception circuit 12, a bus line communication circuit 13, a drive unit 14, a first switching element 15, and a second switching element 16.

The pulse signal generation unit 11 is connected to a pulse signal transmission/reception circuit 12 and a bus line communication circuit 13. The pulse signal generation unit 11 receives feedback from an output line 80. The pulse signal transmission/reception circuit 12 is connected to a bus line communication circuit 13 and a drive unit 14. Furthermore, the pulse signal transmission/reception circuit 12 is connected to a pulse signal transmission/reception circuit 22 of a first slave 20 described later by a daisy chain line 61, and is connected to a pulse signal transmission/reception circuit of a third slave 40 described later by a daisy chain line 64. In addition, the bus line communication circuit 13 is connected to a bus line 50.

The pulse signal generation unit 11 generates a SW instruction signal for switching the first switching elements 15, 25, 35, 45 and the second switching elements 16, 26, 36, 46 of the master 10 and the first, second and third slaves 20, 30, 40 for each switching period. The SW instruction signal is a pulse signal having a duty ratio calculated by the pulse signal generation unit 11. The pulse signal generation unit 11 calculates a duty ratio based on a feedback input of the output voltage Vout so that the output voltage Vout becomes a desired voltage. The duty ratio is the pulse width of the SW instruction signal relative to the operation time, and the pulse width of the SW instruction signal corresponds to the on time of the first switching elements 15, 25 35, and 45. The pulse signal generation unit 11 transmits the generated SW instruction signal to the pulse signal transmission/reception circuit 12 and the bus line communication circuit 13.

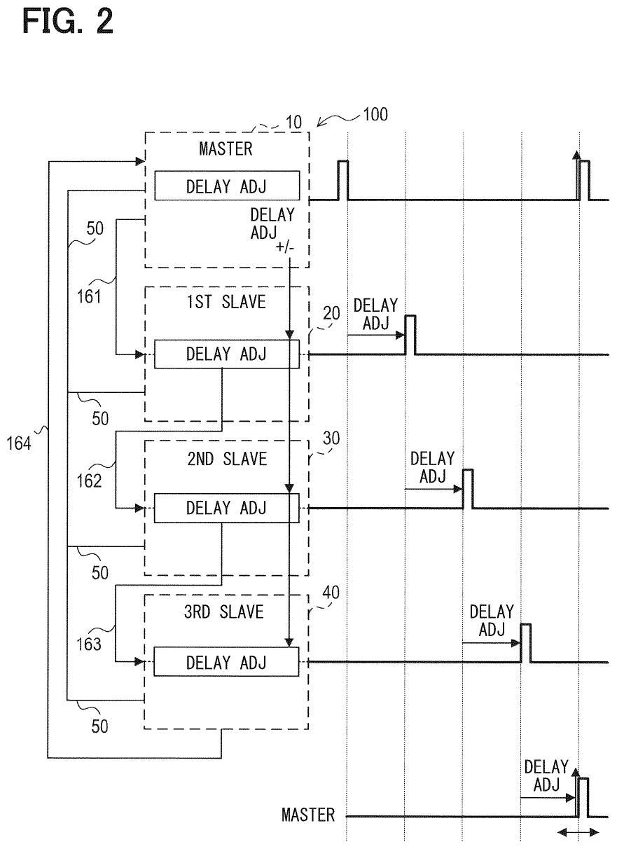

As shown in FIG. 2, the pulse signal transmission/reception circuit 12 adjusts the phase of the SW instruction signal (hereinafter, the first instruction signal) received from the pulse signal generation unit 11 so as to delay the first instruction signal based on the SW instruction signal (hereinafter, the second instruction signal) received from the third slave 40 via the daisy chain line 64. The second instruction signal corresponds to the SW instruction signal generated by the pulse signal generation unit 11 in the previous switching period.

The pulse signal transmission/reception circuit 12 does not transmit the first instruction signal immediately after receiving the first instruction signal from the pulse signal generation unit 11. The pulse signal transmission/reception circuit 12 adjusts the delay of the phase of the first instruction signal so that the first instruction signal is transmitted after waiting until a predetermined time point. The predetermined time point corresponds to a time point when an operation time has elapsed since the pulse signal transmission/reception circuit 12 received the second instruction signal. That is, the pulse signal generation unit 11 waits to transmit the first instruction signal until the operation time of the third slave 40 ends. The pulse signal transmission/reception circuit 12 transmits the delay-adjusted SW instruction signal to the drive unit 14 and the bus line communication circuit 13, and also transmits the delay-adjusted SW instruction signal to the daisy chain line 61.

When the bus line communication circuit 13 receives the SW instruction signal from the pulse signal transmission/reception circuit 12, the bus line communication circuit 13 transmits a response signal to the bus line 50. The response signal is a pulse signal having a certain width. In addition, the bus line communication circuit 13 receives response signals output from the first, second and third slaves 20, 30 and 40. When an anomaly is detected in one of the response signals transmitted from the first, second and third slaves 20, 30 and 40, the bus line communication circuit 13 determines that the slave corresponding to the anomaly response signal has failed. An example of an anomaly in the response signal is the loss of the response signal. The bus line communication circuit 13 can specify the failed slave based on what number of response signals the anomaly occurred after the bus line communication circuit 13 transmitted the response signal.

When the drive unit 14 receives the SW instruction signal from the pulse signal transmission/reception circuit 12, the drive unit 14 generates a first drive signal and a second drive signal based on the SW instruction signal. The drive unit 14 controls the on/off of the first switching element 15 by a first drive signal, and controls the on/off of the second switching element 16 by a second drive signal.

The first switching element 15 and the second switching element 16 are transistors, for example, N-channel type MOS field effect transistors. The gates of the first switching element 15 and the second switching element 16 are individually connected to the drive unit 14. The drain of the first switching element 15 is connected to a first power supply 18, and the source of the first switching element 15 is connected to the drain of the second switching element 16. The source of the first switching element 15 and the drain of the second switching element 16 are connected to the output line 80 via the first resistor 17. The source of the second switching element 16 is grounded.

The drive unit 14 outputs a first drive signal to the gate of the first switching element 15 to control the on/off of the first switching element 15. When the first drive signal is at a high level, the first switching element 15 is turned on, and when the first drive signal is at a low level, the first switching element 15 is turned off. The drive unit 14 outputs a second drive signal to the gate of the second switching element 16 to control the on/off of the second switching element 16. When the second drive signal is at a high level, the second switching element 16 is turned on, and when the second drive signal is at a low level, the second switching element 16 is turned off.

The drive unit 14 turns on the first switching element 15 and turns off the second switching element 16 in accordance with the on-period of the SW instruction signal. The drive unit 14 controls the first switching element 15 and the second switching element 16 in a complementarily manner.

When the first drive signal is at a high level and the second drive signal is at a low level, an output voltage Vout having a potential based on the first power supply 18 is output to the output line 80. When the first drive signal is at a low level and the second drive signal is at a high level, the output signal Vout is pulled down to the ground potential.

The above-described correspondence between the logical levels of the first and second drive signals and the on/off of the first and second switching elements 15 and 16 is merely an example, and the correspondence may be reversed. Moreover, the first switching element 15 and the second switching element 16 may be P-channel MOS transistors, or may be transistors other than MOS transistors.

The first slave 20 is a DC-DC converter that functions as a slave, and includes a pulse signal transmission/reception circuit 22, a bus line communication circuit 23, a drive unit 24, a first switching element 25, and a second switching element 26. The pulse signal transmission/reception circuit 22 is connected to a pulse signal transmission/reception circuit 32 of a second slave 30 (described later) by a daisy chain line 62. In addition, the bus line communication circuit 23 is connected to a bus line 50. The configuration of the first slave 20 is similar to that of the master 10, except that the first slave 20 does not include the pulse signal generation unit 11.

When the pulse signal transmission/reception circuit 22 receives the SW instruction signal via the daisy chain line 61, the pulse signal transmission/reception circuit 22 adjusts the delay of the SW instruction signal in the same manner as the pulse signal transmission/reception circuit 12. The pulse signal transmission/reception circuit 22 transmits the delay-adjusted SW instruction signal to the drive unit 24 and the bus line communication circuit 23, and also transmits the delay-adjusted SW instruction signal to the daisy chain line 62.

When the bus line communication circuit 23 receives the SW instruction signal from the pulse signal transmission/reception circuit 22, the bus line communication circuit 23 transmits a response signal to the bus line 50. In addition, the bus line communication circuit 23 receives response signals output from the master 10, the second slave 30 and the third slave 40. When an anomaly is detected in one of the response signals transmitted from the second and third slaves 30 and 40, the bus line communication circuit 23 determines that the slave corresponding to the anomaly response signal has failed. The bus line communication circuit 23 can specify the failed slave based on what number of response signals the anomaly occurred after the bus line communication circuit 23 transmitted the response signal.

When the drive unit 24 receives the SW instruction signal from the pulse signal transmission/reception circuit 22, the drive unit 24 generates a first drive signal and a second drive signal based on the SW instruction signal. The drive unit 24 controls the on/off of the first switching element 25 and the second switching element 26 by the first drive signal and the second drive signal. The configurations and operations of the drive unit 24, the first switching element 25, and the second switching element 26 are similar to those of the drive unit 14, the first switching element 15, and the second switching element 16, and therefore will not be described in detail here.

The second slave 30 is a DC-DC converter that functions as a slave, and has a similar configuration to the first slave 20. That is, the second slave 30 includes a pulse signal transmission/reception circuit 32, a bus line communication circuit 33, a driving unit 34, a first switching element 35, and a second switching element 36. The pulse signal transmission/reception circuit 32 is connected to the pulse signal transmission/reception circuit 22 by a daisy chain line 63. In addition, the bus line communication circuit 33 is connected to a bus line 50. The configuration of the second slave 30 is similar to the configuration of the first slave 20.

When the pulse signal transmission/reception circuit 32 receives the SW instruction signal via the daisy chain line 62, the pulse signal transmission/reception circuit 32 adjusts the delay of the SW instruction signal in the same manner as the pulse signal transmission/reception circuit 12. The pulse signal transmission/reception circuit 32 transmits the delay-adjusted SW instruction signal to the drive unit 34 and the bus line communication circuit 33, and also transmits the delay-adjusted SW instruction signal to the daisy chain line 63.

When the bus line communication circuit 33 receives the SW instruction signal from the pulse signal transmission/reception circuit 32, the bus line communication circuit 33 transmits a response signal to the bus line 50. In addition, the bus line communication circuit 33 receives response signals output from the master 10, the first slave 20 and the third slave 40. When an anomaly is detected in one of the response signals transmitted from the first and third slaves 20 and 40, the bus line communication circuit 33 determines that the slave corresponding to the anomaly response signal has failed.

When the drive unit 34 receives the SW instruction signal from the pulse signal transmission/reception circuit 32, the drive unit 34 generates a first drive signal and a second drive signal based on the SW instruction signal. The drive unit 34 controls the on/off of the first switching element 35 and the second switching element 36 by the first drive signal and the second drive signal. The configurations and operations of the drive unit 34, the first switching element 35, and the second switching element 36 are similar to those of the drive unit 14, the first switching element 15, and the second switching element 16, and therefore will not be described in detail here.

The third slave 40 is a DC-DC converter that functions as a slave, and has a similar configuration to the first slave 20. Details of the third slave 40 will be omitted. When the third slave 40 receives the SW instruction signal via the daisy chain line 63, the third slave 40 adjusts the delay of the SW instruction signal. The third slave 40 transmits the delay-adjusted SW instruction signal to the daisy chain line 64 and transmits the response signal to the bus line 50.

In this embodiment, the pulse signal generation unit 11 of the master 10 corresponds to the control unit of the present disclosure.

### <1-2. Operation>

### <1-2-1. If a Slave Fails>

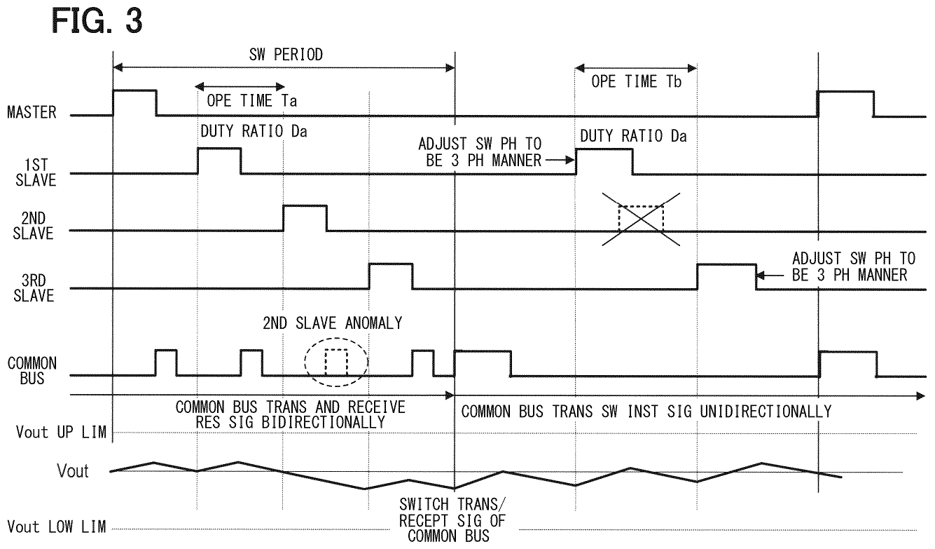

As shown in FIG. 3, the operation of the multi-phase power source circuit 100 when any of the slaves of the multi-phase power source circuit 100 fails will be described.

In a normal operation, the master 10 and the first, second and third slaves 20, 30 and 40 operate in sequence at a duty ratio Da for an operation time Ta in one switching period. The master 10 and the first, second and third slaves 20, 30 and 40 check each other's operation (specifically, whether they are operating normally or whether an anomaly has occurred) by transmitting and receiving response signals via the bus line 50. Each of the master 10 and the first, second and third slaves 20, 30 and 40 detects the number of phases based on the number of response signals received during the period from when the master 10 receives a SW instruction signal until when the master 10 receives the next SW instruction signal.

When the master 10 and the first, second and third slaves 20, 30 and 40 determine that any of the slaves has failed, the master 10 and the first, second and third slaves 20, 30 and 40 do not change the switching period but change the operation time Ta to the operation time Tb so as to compensate for the output of the failed slave. By maintaining the switching period constant, noise generated by the multi-phase power source circuit 100 can be suppressed. The remaining three DC-DC converters other than the failed slave operate at the duty ratio Da for the operation time Tb in turn.

As shown in FIG. 3, if the second slave 30 fails, the master 10 and the first and third slaves 20 and 40 determine the failure of the second slave 30 based on an anomaly (e.g., loss) of the response signal that should be transmitted from the second slave 30. Then, the master 10 and the first and third slaves 20, 40 change the operation time Ta to the operation time Tb (specifically, lengthen the operation time) so that the multi-phase power source circuit 100 can output the same output voltage Vout in three-phase operation as in four-phase operation. When the number of phases changes from 4 to 3, the operation time Tb is 4/3 times the operation time Ta. That is, when the phase changes from N (here, N is a natural number) to M (here, M is a natural number smaller than N), the operation time is multiplied by N/M. When the phase master 10 and the first, second and third slaves 20, 30 and 40 detect a failure in any of the slaves, the phase master 10 and the first, second and third slaves 20, 30 and 40 adjust the operation time by referring to the above-mentioned correspondence table, and adjust the delay of the SW instruction signal based on the changed operation time.

After determining that the second slave 30 has failed, the master 10 and the first and third slaves 20 and 40 stop transmitting response signals to the bus line 50. Since the master 10 cannot transmit a SW instruction signal using the daisy chain lines 61 to 64 due to a failure of the second slave 30, the master 10 transmits a SW instruction signal to the bus line 50 to notify the switching timing and the duty ratio. The master 10 repeatedly transmits a SW instruction signal in a switching period.

When the first and third slaves 20 and 40 receive the SW instruction signal via the bus line 50, the first and third slaves 20 and 40 adjust the delay of the SW instruction signal and operate based on the SW instruction signal after the delay adjustment. In detail, the first slave 20 recognizes that the order of the operation of the first slave 20 is next after the master 10 based on the transmission and reception of the response signal. Therefore, the first slave 20 delays the phase of the SW instruction signal until the operation time Tb has elapsed since the first slave 20 received the SW instruction signal via the bus line 50. Furthermore, the third slave 40 recognizes that due to the failure of the second slave 30, the order of the operation of the third slave 40 is next after the first slave 20. Therefore, the third slave 40 delays the phase of the SW instruction signal until double of the operation time, i.e., “Tb×2” has elapsed since the first slave 20 received the SW instruction signal via the bus line 50.

If the master 10 determines that an anomaly has occurred in the response signals from multiple slaves and that multiple slaves have failed, the master 10 stops controlling the first, second and third slaves 20, 30 and 40 and shuts down the output of the multi-phase power source circuit 100.

### <1-2-2. If the Daisy Chain is Interrupted>

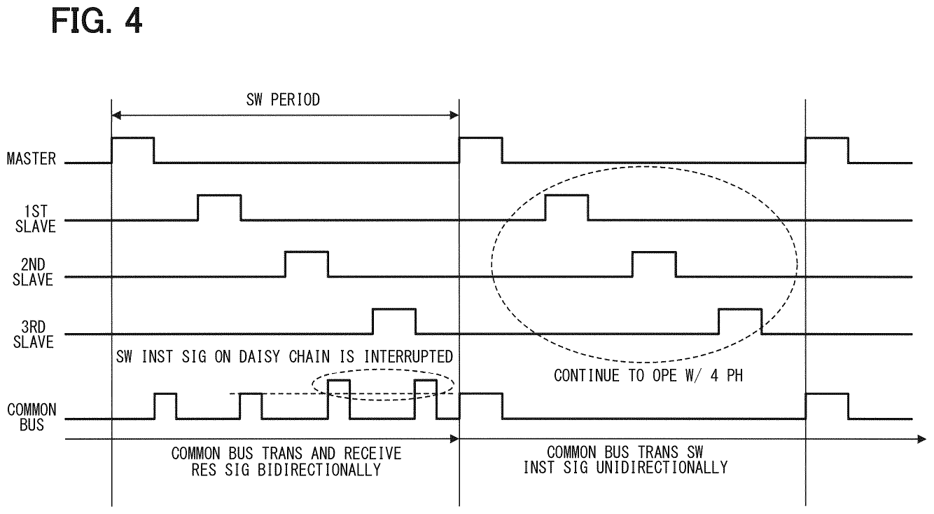

The operation of the multi-phase power source circuit 100 when the daisy chain is interrupted will be described with reference to FIG. 4.

If any of the daisy chain lines 61 to 64 is broken, the daisy chain is interrupted, and multiple DC-DC converters among the master 10, and the first, second and third slaves 20, 30 and 40 are unable to receive the SW instruction signal. If the daisy chain lines 61 to 64 are simply disconnected somewhere and none of the first, second and third slaves 20, 30 and 40 are failed, the multi-phase power source circuit 100 can continue to operate in four phases.

In order for the multi-phase power source circuit 100 to operate in four phases even if the daisy chain is interrupted, the master 10 needs to determine that the daisy chain is interrupted. Furthermore, the master 10 needs to supply the SW instruction signal to the first, second and third slaves 20, 30 and 40 without using the daisy chain lines 61-64.

Therefore, when the first, second and third slaves 20, 30 and 40 cannot receive the SW instruction signal, the first, second and third slaves 20, 30 and 40 output to the bus line 50 the modification response signal that differs from that used in the normal operation. In the normal operation, the first, second and third slaves 20, 30 and 40 receive a SW instruction signal via the daisy chain lines 61, 62 and 63 for each switching period. The first, second and third slaves 20, 30 and 40 output a modification response signal to the bus line 50 when the first, second and third slaves 20, 30 and 40 have not received a SW instruction signal even though a switching period has elapsed since the first, second and third slaves 20, 30 and 40 received the previous SW instruction signal. The modification response signal is a signal in which the voltage amplitude or pulse width of the response signal during the normal operation has been changed, and is, for example, a signal whose voltage amplitude level is higher or lower than that of the response signal during the normal operation.

After receiving the modification response signal, the master 10 and the first, second and third slaves 20, 30 and 40 stop outputting the response signal to the bus line 50. Then, the master 10 transmits a SW instruction signal to the bus line 50 for each switching period to notify the switching timing and the duty ratio. The first, second and third slaves 20, 30, 40 receive the SW instruction signal via the bus line 50. The first, second and third slaves 20, 30 and 40 recognize their own operation order by transmitting and receiving the response signal. The first, second and third slaves 20, 30 and 40 adjust the delay of the SW instruction signal received via the bus line 50 based on the order of their own operations. The first, second and third slaves 20, 30 and 40 then operate based on the delay-adjusted SW instruction signal.

### <1-3. Effects>

According to a first embodiment described in detail above, the following effects are achieved.

(1) In the multi-phase power source circuit 100, when a failure is determined in any of the first, second and third slaves 20, 30 and 40, the operation times of the master 10 and the remaining slaves are changed to compensate for the output of the failed slave. Therefore, the multi-phase power source circuit 100 can continue to provide the desired output even if any of the slaves fails.

(2) The master 10 and the first, second and third slaves 20, 30 and 40 are connected by the daisy chain lines 61 to 64, and SW instruction signals are transmitted sequentially via the daisy chain lines 61 to 64, thereby enabling the first, second and third slaves 20, 30 and 40 to recognize their own switching timing. Furthermore, since the master 10 and the first, second and third slaves 20, 30 and 40 are connected by the bus line 50, the master 10 and the first, second and third slaves 20, 30 and 40 can output response signals to the bus line 50 at their own switching timing to confirm each other's operation. Furthermore, if any of the first, second and third slaves 20, 30 and 40 fails, the master 10 can detect the failure of any of the slaves, specify the failed slave and allow the remaining slaves to continue operating to compensate for the output of the failed slave.

(3) If the daisy chain is interrupted, a slave that has not received the SW instruction signal outputs a modification response signal to the bus line 50, thereby enabling the master 10 to determine that the daisy chain has been interrupted. Furthermore, the master 10 outputs a response signal to the bus line 50, so that the multi-phase power source circuit 100 can continue to operate with the original number of phases.

### Second Embodiment

<2-1. Differences from First Embodiment>

A basic configuration of the second embodiment is the same as that of the first embodiment, and therefore, differences from the first embodiment will be described below. The same reference numerals as in the first embodiment denote the same elements, and reference is made to the preceding description.

The multi-phase power source circuit 110 according to the second embodiment differs from the multi-phase power source circuit 100 according to the first embodiment in that the multi-phase power source circuit 110 does not include the daisy chain lines 61 to 64.

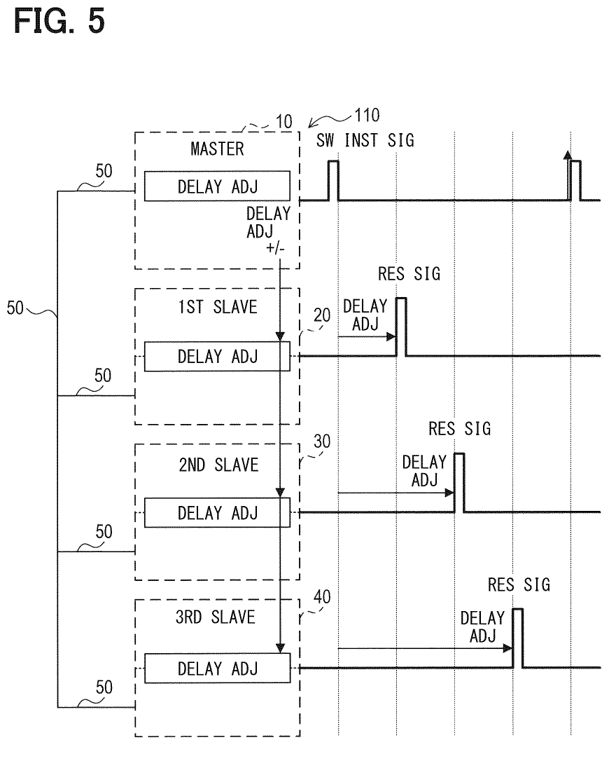

As shown in FIG. 5, in the multi-phase power source circuit 110, the master 10, the first slave 20, the second slave 30, and the third slave 40 are connected by a bus line 50, but are not connected by daisy chain lines 61 to 64. The configuration of the multi-phase power source circuit 110 is similar to that of the multi-phase power source circuit 100, except that the multi-phase power source circuit 110 does not include the daisy chain lines 61 to 64.

### <2-2. Operation>

The operation of the multi-phase power source circuit 110 will now be described with reference to FIG. 5. in a normal operation, the master 10 transmits a SW instruction signal to the bus line 50 for each switching period to notify the first, second and third slaves 20, 30 and 40 of the switching timing and the duty ratio.

When the first, second and third slaves 20, 30 and 40 receive the SW instruction signal via the bus line 50, the first, second and third slaves 20, 30 and 40 adjust the delay of the SW instruction signal based on their own operation order. The first, second and third slaves 20, 30 and 40 then operate based on the delay-adjusted SW instruction signal and output a response signal to the bus line 50 at the operation timing. The response signal is a pulse signal having a higher voltage level than the SW instruction signal so that the response signal can be distinguished from the SW instruction signal. The response signal may be a pulse signal having a lower voltage level than the SW instruction signal.

Here, the first, second and third slaves 20, 30 and 40 have the same hardware configuration and cannot be distinguished from one another based on the hardware configuration. Therefore, in the multi-phase power source circuit 100, the master 10 and the first, second and third slaves 20, 30 and 40 recognize the number of phases and the order of their own operations by transmitting SW instruction signals in sequence via the daisy chain lines 61 to 64.

Since the multi-phase power source circuit 110 does not include the daisy chain lines 61 to 64, the first, second and third slaves 20, 30 and 40 each include a port for recognizing a slave number. During the activation operation, a signal of several bits different from each other is input to each of the recognition ports of the first, second and third slaves 20, 30 and 40 by pull-up and pull-down of the peripheral circuits. The first, second and third slaves 20, 30 and 40 determine the high/low level of a several-bit signal input to their recognition ports and recognize their own slave numbers (i.e., the order of operations).

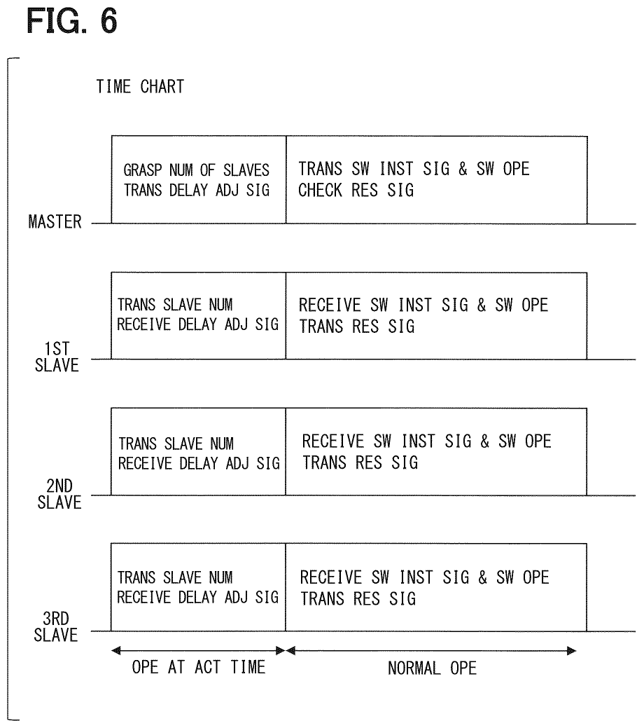

As shown in FIG. 6, in the activation operation, the first, second and third slaves 20, 30 and 40 transmit number signals corresponding to their own recognized slave numbers to the bus line 50. The master 10 receives the number signals via the bus line 50, and recognizes the number of slaves (i.e., the number of phases) based on the number of number signals received.

The master 10 determines an operation time based on the recognized number of phases, and transmits a delay adjustment signal corresponding to the operation time to the bus line 50. The first, second and third slaves 20, 30, 40 receive the delay adjustment signal via a bus line 50. Thereafter, the master 10 and the first, second and third slaves 20, 30 and 40 transition from the activation operation to the normal operation. The first, second and third slaves 20, 30 and 40 adjust the delay of the SW instruction signal received via the bus line 50 based on the received delay adjustment signal and their own slave numbers.

More specifically, since the first slave 20 recognizes that the first slave 20 is the first slave, the first slave 20 delays the phase of the SW instruction signal until the operation time has elapsed since the first slave 20 received the SW instruction signal. The second slave 30 recognizes that the second slave 30 is the second slave, and therefore the second slave 30 delays the phase of the SW instruction signal until double of the operation time “operation time×2” has elapsed since the second slave 30 received the SW instruction signal. The third slave 40 recognizes that the third slave 40 is the third slave, and therefore the third slave 40 delays the phase of the SW instruction signal until triple of the operation time “operation time×3” has elapsed since the third slave 40 received the SW instruction signal.

Furthermore, when the master 10 and the first, second and third slaves 20, 30 and 40 determine that any of the slaves has failed based on an anomaly in the response signal, the remaining DC-DC converters change their operation times so as to compensate for the output of the failed slave. Specifically, similarly to the first embodiment described above, the master 10 changes the operation time based on a correspondence table between the number of operation phases and the operation time at a constant switching period, and continues the operation.

### <2-3. Effects>

According to the second embodiment described in detail above, the effect (1) of the first embodiment described above is obtained, and the following effects are further obtained.

(4) In the multi-phase power source circuit 110, the voltage level of the response signal is made different from the voltage level of the SW instruction signal, so that the response signal and the SW instruction signal are transmitted separately using the same bus line 50. Therefore, even if the multi-phase power source circuit 110 does not have a daisy chain line, the master 10 can determine a failure in any of the slaves via the bus line 50 and can cause the remaining slaves to continue operating so as to compensate for the output of the failed slave.

### 3. Third Embodiment

<3-1. Differences from First Embodiment>

A basic configuration of the third embodiment is the same as that of the first embodiment, and therefore, differences from the first embodiment will be described below. The same reference numerals as in the first embodiment denote the same elements, and reference is made to the preceding description.

The multi-phase power source circuit 200 according to the third embodiment differs from the first embodiment in that the multiple DC-DC converters are not divided into master and slave functions, and their operation is controlled by a control circuit provided separately from the multiple DC-DC converters.

### <3-2. Configuration>

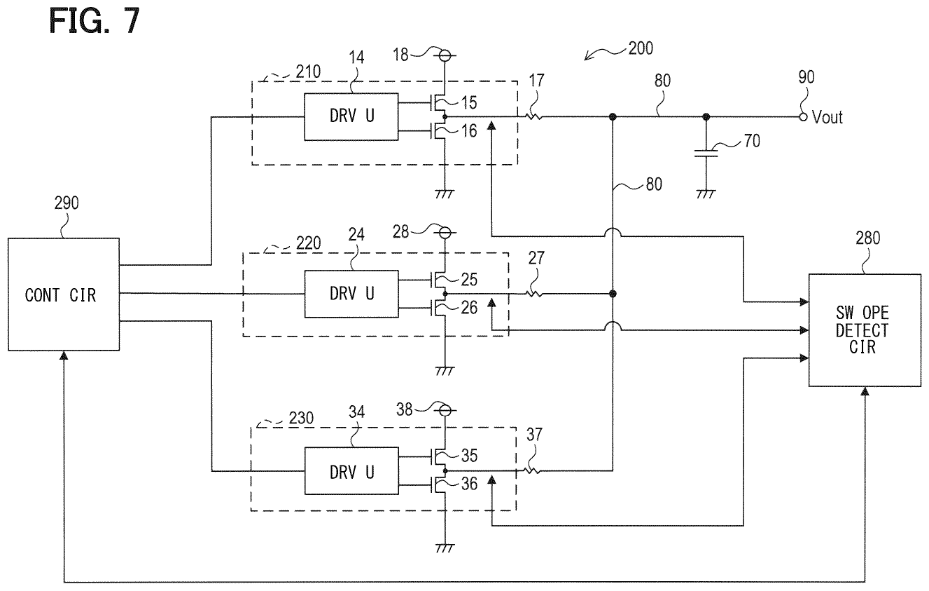

As shown in FIG. 7, the multi-phase power source circuit 200 according to the third embodiment includes a control circuit 290, a switching operation detection circuit 280, a first converter 210, a second converter 220, a third converter 230, a first resistor 17, a second resistor 27, a third resistor 37, a first power supply 18, a second power supply 28, a third power supply 38, a smoothing capacitor 70, an output line 80, and an output terminal 90. The first, second and third converters 210, 220 and 230 are connected to the output line 80 in parallel to each other via the first, second and third resistors 17, 27 and 37, respectively.

The first, second and third converters 210, 220 and 230 are DC-DC converters having the same configuration. The first converter 210 includes a drive unit 14, a first switching element 15, and a second switching element 16. The second converter 220 includes a drive unit 24, a first switching element 25, and a second switching element 26. The third converter 230 includes a drive unit 34, a first switching element 35, and a second switching element 36. The drive units 14, 24, 34 respectively control the on/off of the first switching elements 15, 25, 26 and the second switching elements 16, 26, 36 based on a SW instruction signal from the control circuit 290.

The control circuit 290 stores a correspondence table between the number of operation phases and the operation time. In the normal operation, when the control circuit 290 detects the number of phases, the control circuit 290 refers to the correspondence table and sets the operation time according to the number of phases. The control circuit 290 transmits SW instruction signals to the drive units 14, 24, and 34 in sequence, with the operation times shifted from one another.

The switching operation detection circuit 280 is connected to the first connection point, the second connection point, the third connection point, and the control circuit 290. The first connection point is a connection point between the first switching element 15 and the second switching element 16. The second connection point is a connection point between the first switching element 25 and the second switching element 26. The third connection point is a connection point between the first switching element 35 and the second switching element 36.

The switching operation detection circuit 280 detects whether the first, second and third converters 210, 220 and 230 are operating based on the potentials of the first connection point, the second connection point and the third connection point. Then, the switching operation detection circuit 280 transmits the detected information about the presence or absence of switching operations of the first, second, and third converters 210, 220, 230 to the control circuit 290.

When the control circuit 290 does not detect a switching operation of the converter of the transmission destination despite transmitting the SW instruction signal, the control circuit 290 determines that the converter of the transmission destination has failed. For example, when the control circuit 290 does not detect the operation of the second converter 220 despite transmitting a SW instruction signal to the second converter 220, the control circuit 290 determines that the second converter 220 has failed.

When the control circuit 290 determines that any of the first, second, and third converters 210, 220, and 230 has failed, the control circuit 290 refers to the correspondence table and changes the operation time so as to compensate for the output of the failed converter at a predetermined switching period. Then, the control circuit 290 transmits SW instruction signals corresponding to the changed operation times to the remaining converters in turn.

### <3-3. Effects>

According to the third embodiment described in detail above, the effect (1) of the first embodiment described above is obtained, and the following effects are further obtained.

(5) When any of the first, second, and third converters 210, 220, and 230 fails, the control circuit 290 can determine whether the converter has failed based on whether or not an SW instruction signal is output and whether or not the first, second, and third converters 210, 220, and 230 are operating. Thus, the control circuit 290 then allows the remaining converters to continue operating to compensate for the output of the failed converter.

### 4. Other Embodiments

Although the embodiments of the present disclosure have been described above, the present disclosure is not limited to the above embodiments, and various modifications can be made.

(a) In the above embodiments, when a failure is detected in any of the multiple DC-DC converters, the multi-phase power source circuits 100, 110, 200 change the operation time of each DC-DC converter without changing the switching period. Alternatively, it is also possible to change the switching period without changing the operation time. Specifically, when a failure is detected in any of the multiple DC-DC converters, the multi-phase power source circuits 100, 110, and 200 may shorten the switching period while maintaining the operation time to be constant in order to compensate for the output of the failed DC-DC converter. For example, when the number of phases changes from N (here, N is a natural number) phases to M (here, M is a natural number smaller than N) phases, the switching period is multiplied by M/N.

(b) In the first embodiment, after it is determined that a failure has occurred in any of the multiple slaves, the master 10 and the remaining slaves stop transmitting response signals to the bus line 50. Alternatively, as in the second embodiment, a response signal of a voltage level different from that of the SW instruction signal may be transmitted to the bus line 50. Then, if a failure is determined in yet another slave, the master 10 may further change the operation time to allow the remaining slaves to continue operating.

(C) The multiple functions of one component in the above embodiments may be realized by multiple components, or a function of one component may be realized by multiple components. Further, multiple functions of multiple elements may be implemented by one element, or one function implemented by multiple elements may be implemented by one element. Part of the configuration of the above embodiment may be omitted. At least a part of the configuration of the above embodiment may be added to or substituted for the configuration of the other embodiment.

(d) In addition to the multi-phase power source circuit described above, the present embodiments can be realized in various forms, such as a system including the multi-phase power source circuit as a component, and a method of operating the multi-phase power source circuit.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A multi-phase power source circuit comprising:
a plurality of DC-DC converters; and
a control unit configured to operate each of the plurality of DC-DC converters for a predetermined operation time in a predetermined switching period so that operation periods of the plurality of DC-DC converters are shifted from one another, wherein:
the control unit is configured, when a failure is detected in any of the plurality of DC-DC converters, to change the predetermined switching period or the predetermined operation time of remaining DC-DC converters other than a failure DC-DC converter so as to compensate for an output of the failure DC-DC converter.

2. The multi-phase power source circuit according to claim 1, further comprising:
a first wiring that connects the plurality of DC-DC converters in a bus system; and
a second wiring that connects the plurality of DC-DC converters in a daisy chain manner, wherein:
each of the plurality of DC-DC converters is configured to:
transmit and receive a first signal via the first wiring; and
confirm each other's operations based on the first signal received via the first wiring;
the control unit is connected to the first wiring and the second wiring;
the control unit transmits a second signal to each of the plurality of DC-DC converters in sequence via the second wiring to control a switching timing of each of the plurality of DC-DC converters; and
when any of the first signals transmitted from the plurality of DC-DC converters is anomaly, the control unit detects the failure of any of the plurality of DC-DC converters, specifies the failure DC-DC converter, and changes the predetermined operation time of the remaining DC-DC converter.

3. The multi-phase power source circuit according to claim 2, wherein:
the control unit is configured to transmit the second signal to each of the plurality of DC-DC converters via the first wiring when the second signal is interrupted.

4. The multi-phase power source circuit according to claim 1, further comprising:
a bus wiring that connects the plurality of DC-DC converters in a bus system, wherein:
each of the plurality of DC-DC converters is configured to:
transmit and receive a first signal via the bus wiring; and
confirm each other's operations based on the first signal received via the bus wiring;
the control unit is connected to the bus wiring;
the control unit transmits a second signal different from the first signal to the bus wiring to control an operation timing of each of the plurality of DC-DC converters; and
when any of the first signals transmitted from the plurality of DC-DC converters is anomaly, the control unit detects the failure of any of the plurality of DC-DC converters, specifies the failure DC-DC converter, and changes the predetermined operation time.

5. The multi-phase power source circuit according to claim 1, further comprising:
an operation detection circuit connected to each of the plurality of DC-DC converters and configured to detect operation of each of the plurality of DC-DC converters, wherein:
the control unit is configured to detect a failure of any of the plurality of DC-DC converters based on an output of the operation detection circuit, specify the failure DC-DC converter, and change the predetermined operation time.
